(19) United States
(12) Patent Application Publication
(10) Pub. No.: US 2026/0065118 A1
(43) Pub. Date: Mar. 5, 2026

(54) AUXILIARY STATE-BASED DIGITAL QUANTUM ALGORITHM FOR MOLECULAR VIBRONIC SPECTRA

(71) Applicant: International Business Machines Corporation, Armonk, NY (US)

(72) Inventors: Niall Robertson, Dublin (IE); Sumit Suresh Kale, Bangalore (IN); Omar Shehab, Yorktown Heights, NY (US)

(21) Appl. No.: 18/754,087

(22) Filed: Jun. 25, 2024

(51) Int. Cl. G06N 10/60; G06N 10/40

(52) U.S. Cl. CPC G06N 10/60; G06N 10/40

(57) ABSTRACT

A system comprises a memory that stores computer executable components, and a processor that executes the computer executable components stored in the memory, wherein the computer executable components comprise a determining component that determines a non-arbitrary auxiliary quantum state to be prepared at a quantum system in correlation with execution of a quantum algorithm that represents an autocorrelation function corresponding to a specified vibronic spectrum, and an executing component that obtains a set of measurements corresponding to the autocorrelation function by controlling an execution of the quantum algorithm based on the non-arbitrary auxiliary quantum state as an initial qubit state for the quantum system.

### STATEMENT OF GOVERNMENT SUPPORT

This invention was made with government support under HR001122C0102 awarded by Defense Advanced Research Projects Agency (DARPA). The government has certain rights to this invention.

### BACKGROUND

The subject disclosure relates to quantum computing systems and more specifically to determination of a vibrationally resolved electronic spectrum using a quantum computing system.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for determining a vibrationally resolved electronic spectrum of a molecule.

In accordance with an embodiment, a system can comprise a memory that stores computer executable components; and a processor that executes the computer executable components stored in the memory, wherein the computer executable components comprise a determining component that determines a non-arbitrary auxiliary quantum state to be prepared at a quantum system in correlation with execution of a quantum algorithm that represents an autocorrelation function corresponding to a specified vibronic spectrum, and an executing component that obtains a set of measurements corresponding to the autocorrelation function by controlling an execution of the quantum algorithm based on the non-arbitrary auxiliary quantum state as an initial qubit state for the quantum system.

In accordance with another embodiment, a computer-implemented method can comprise determining, by a system operatively coupled to a processor, a non-arbitrary auxiliary quantum state to be prepared at a quantum system in correlation with execution of a quantum algorithm that represents an autocorrelation function corresponding to a specified vibronic spectrum, and obtaining, by the system, a set of measurements corresponding to the autocorrelation function by controlling an execution of the quantum algorithm based on the non-arbitrary auxiliary quantum state as an initial qubit state for the quantum system.

In accordance with still another embodiment, a computer program product, facilitating a process to determine a vibrationally resolved electronic spectrum of a molecule, can comprise a computer readable storage medium having program instructions embodied therewith, the program instructions executable by a processor to cause the processor to determine, by the processor, a non-arbitrary auxiliary quantum state to be prepared at a quantum system in correlation with execution of a quantum algorithm that represents an autocorrelation function corresponding to a specified vibronic spectrum and obtain, by the processor, a set of measurements corresponding to the autocorrelation function by controlling an execution of the quantum algorithm based on the non-arbitrary auxiliary quantum state as an initial qubit state for the quantum system.

A benefit of the system, computer-implemented method and/or computer program product can be an ability to, during quantum experiment setup, perform an easy initialization of initial states of the qubits being employed in that the quantum circuit executed and/or controlled to be executed by the system, computer-implemented method and/or computer program product employs a ground state of zero or one for each of the qubits being employed. This can allow for quick and efficient preparation for execution of a subsequent quantum algorithm.

Another benefit of the system, computer-implemented method and/or computer program product can be an ability to employ magnitudes fewer gates than conventional frameworks for determining a vibrationally resolved electronic spectrum of a molecule. That is, a number of cycles, a number of qubits employed, a quantum circuit qubit depth, a quantum circuit gate quantity, a quantum circuit gate complexity, a power employed and/or a time employed to determine such vibrationally resolved electronic spectrum can be significantly reduced as compared to conventional frameworks.

Yet another benefit of the system, computer-implemented method and/or computer program product can be a reduction in errors caused and/or assumptions taken to determine the vibrationally resolved electronic spectrum of a molecule, such as in view of lack of use of quantum phase estimation and/or fault tolerancing. In connection therewith, the system, computer-implemented method and/or computer program product can employ a framework that is easily amenable to error mitigation, as compared to conventional frameworks employing quantum phase estimation (QPE) for which error mitigation at a level necessary for determination of vibrationally resolved electronic spectra is not presently possible.

Still another benefit of the system, computer-implemented method and/or computer program product can be an ability for use thereof with industries requiring rapid determination of vibrationally resolved electronic spectra for manufacturing of large quantities of products, such as with respect to spectra of lithium ions relative to battery manufacturing.

### DESCRIPTION OF THE DRAWINGS

FIG. 1 illustrates a block diagram of an example, non-limiting system that can provide a process to determine a vibrationally resolved electronic spectrum, in accordance with one or more embodiments described herein.

FIG. 2 illustrates a block diagram of another example, non-limiting system that can provide a process to determine a vibrationally resolved electronic spectrum, in accordance with one or more embodiments described herein.

FIG. 3 illustrates a block diagram of a quantum system that can be employed in connection with the non-limiting systems of FIGS. 1 and 2, in accordance with one or more embodiments described herein.

FIG. 4 provides a diagrammatic illustration of a quantum circuit of a conventional framework to provide an example for defining one or more benefits associated with at least FIGS. 2 and 5.

FIG. 5 provides an illustration of varying sets of elements of a quantum algorithm that can be employed and/or generated by the non-limiting system of FIG. 2, and executed by the quantum system of FIG. 3, in accordance with one or more embodiments described herein.

FIG. 6 illustrates a flow diagram of one or more processes that can be performed by the non-limiting system of FIG. 2, to determine a vibrationally resolved electronic spectrum, in accordance with one or more embodiments described herein.

FIG. 7 illustrates a block diagram of a set of processes that can be performed by the non-limiting system of FIG. 2, in accordance with one or more embodiments described herein.

FIG. 8 illustrates a graph demonstrating one or more processes that can be performed by the non-limiting system of FIG. 2, in accordance with one or more embodiments described herein.

FIG. 9 illustrates a flow diagram of one or more processes that can be performed by the non-limiting system of FIG. 2, to determine a vibrationally resolved electronic spectrum, in accordance with one or more embodiments described herein.

FIG. 10 illustrates a continuation of the flow diagram of FIG. 9 of one or more processes that can be performed by the non-limiting system of FIG. 2, in accordance with one or more embodiments described herein.

FIG. 11 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As a brief summary, in practice, calculating a molecule's absorption spectrum can aid interpretation of experimental spectrum and/or can guide cost-effective laboratory synthesis for compounds with certain optical characteristics. Given the rich complex vibrational structure of molecules, the classical computation of accurate vibrationally resolved electronic (e.g., vibronic) spectra can scale combinatorially. Conventional quantum algorithms follow a fault-tolerant approach that necessitates extremely deep quantum circuits and multiple controlled trotterized gates. Differently, proposed herein is a resource-efficient near-term quantum framework that can drastically reduce the depth and breadth of a quantum circuit being employed for determining a vibrationally resolved electronic spectrum (VRES), also herein referred to as a vibronic spectrum.

Turning first to spectroscopy generally, spectroscopy can be a good method for analyzing light-matter interactions. For example, an associated technique can be employed to ascertain whether a specific molecule is present in a sample and/or to calculate a concentration of the specific molecule in the sample. This information can be ascertained from the construction of a vibronic spectrum, whether in a computer-readable data format, user entity-readable data format, and/or in a graphed, visual format. Specificity of the technique can enable compounds in a sample to be identified from one another. Uses are many and can include chemical analysis (such as in lithium battery production), environmental monitoring, molecular physics, biosensing and/or bioimaging. For theoretical models of molecules, the computation of spectra can provide a benchmark. Indeed, an understanding of chemical phenomena can depend on a connection between theory and experiment.

Molecular spectra can be difficult to predict, particularly for large molecular systems, for molecules which show significant entanglement between degrees of freedom, and/or in situations where exceptional accuracy of spectra resolution is desired. In one type of spectra, that of a vibronic spectrum (i.e., a vibrationally resolved electronic spectrum), a vibronic transition can be proportional to an overlap between initial and final vibrational wavefunctions. Calculations for the full vibronic spectrum can often suffer from an issue of dimensionality due to inclusion of an exponential number of relevant vibrational states. That is, calculation of vibronic spectra can scale exponentially. Put another way, calculation of vibronic spectra is a difficult problem in chemical physics because the dimension of the Hilbert space increases exponentially as the problem size (d=m^{3N-6})¹, where d is the dimension, m is number of states allowed in one normal mode, and N is the number of atoms in a respective system.

This dimensionality issue impacts classical algorithms, restricting their application to smaller molecular systems only. For example, anharmonic treatment is difficult in classical computing restricting its utility to smaller molecules, such as those with at most about six atoms.

When looking to quantum simulation, such as to lower a computational expense involved in predicting molecular spectra, a potential advantage can come from an intrinsic ability to naturally map and process high dimensional entangled wavefunctions. However, conventional approaches employing quantum simulation employ an exceedingly long preparation of an initial state, require an abundance of assumptions, such as to get around the dimensions of a respective Hilbert space, and/or result in a variety of known errors. This can undesirably lead to very deep circuits. Furthermore, various algorithm types, such as quantum phase estimation (QPE) simply cannot be implemented on current or even near-term quantum systems due to issues of control qubit quantity, quantum circuit depth and/or errors in measurement of a lengthy qubit bit string.

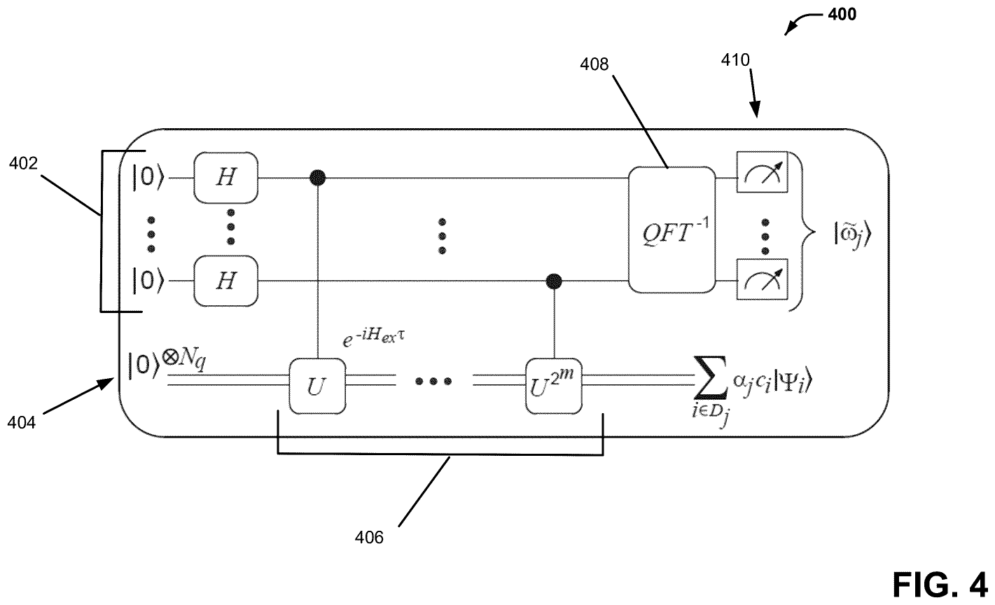

For example, turning to FIG. 4, illustrated is a schematic diagram of an exemplary quantum circuit 400 of a conventional approach using quantum phase estimation (QPE), which is illustrated to highlight one or more benefits of one or more embodiments described herein that can build upon and/or account for one or more efficiencies of the conventional approach. That is, use of QPE can require employment of both a plurality of ancilla/control qubits 402 and a plurality of data qubits 404. Due to the use of the plurality of control qubits 402, the quantum circuit 400 is deep and long, requiring execution of numerous gates related to a plurality of unitaries 406, the number of which can increase exponentially relative to increase in molecule size. In connection therewith the quantum circuit aspect 408, representing a fault tolerant quantum algorithm, and executed as a quantum fault tolerant sub-circuit (QFT⁻¹ sub-circuit), is a deep and complex quantum circuit in itself. Execution of these unitaries 406 and the circuit aspect 408 is not only overly-time consuming, overly-energy consuming, overly-resource consuming and complex, but also can be impossible with larger molecules due to limitations of current and/or near-term quantum systems. Furthermore, as a result of the above, execution of determination of a measurement readout requires measurement of a full set of qubits of a particular bitstring 410 to get energy |\tilde{ω}ⱼ [symbol] , which is both complex and inefficient, and in some cases, can be impossible with larger molecules due to limitations of current and/or near-term quantum systems.

To account for one or more of these deficiencies, the one or more frameworks discovered by the inventors and discussed herein can be employed for determining a vibrationally resolved electronic spectrum of a molecule using a combination of classical computation and quantum computing to provide a framework that is both easier and more efficient than conventional frameworks for vibronic spectra determination.

Generally, the one or more frameworks discussed herein can provide for omission of fault tolerance and be amenable to error mitigation. For example, the one or more frameworks discussed herein can provide for implementation of a set of quantum algorithms using easy and/or efficient to set up ground states of zero and one, with a majority of ground states being zero. The one or more frameworks discussed herein can be employed relative to large molecules without use of various Hilbert space assumptions/approximations, without incurrence of various assumption-based/approximation-based errors, without controlled unitaries, and/or without costly quantum system initialization which all are associated with conventional approaches.

As used herein, a harmonic approximation refers to an assumption that a potential energy of a vibrational Hamiltonian is a quadratic function.

For example, the rotation-based approach discussed herein can employ significantly fewer resources (e.g., qubits) than conventional approaches due to these benefits. The rotation-based approach, for determining a Franck-Condon profile, is based on a fact that quantities such as |α(t)|²≡| [symbol] 0|e^{-iHt}|0 [symbol] |² can be efficiently measured on quantum hardware by measuring probability to measure a second state |0 [symbol] ^{⊗L} after preparing a first state e^{-iHt}|0 [symbol] . A Franck-Condon profile refers to a vibronic spectrum and to calculation of a set of resonance frequencies and heights of peaks of the resonance frequencies relative to a molecule of interest.

As a result, a vibrationally resolved electronic spectrum can be generated having an industry-accepted accuracy of resolution, such as of 50 cm⁻¹ resolution, without the use of a plurality of control qubits or controlled unitaries. Indeed, due use of vibrational Hamiltonians, such forms can have a simple ground state where a majority of states of the respective qubits can be set to zero, with one or more others set only to one. Thus, a natural state, or easily prepared state, of a quantum system can generally be employed for initialization, drastically reducing time, effort and/or complexity of related quantum execution.

As such, the one or more embodiments described herein can provide for automatic or at least partially automatic generation of, and control of execution of, a set of quantum circuits for determining a VRES. Put another way, the one or more embodiments described herein can employ a combination of classical and quantum processes performed on physical qubits of a quantum processor to provide one or more quantum measurement readouts that can be employed, by the one or more embodiments, to determine one or more expectation values, which in turn can be employed, by the one or more embodiments, to generate specified vibronic spectrum by use of a post-measurement, Fourier transform-based analysis approach.

As used herein, the term “data” can comprise metadata.

As used herein, the terms “entity,” “requesting entity,” “user entity,” and “administrating entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

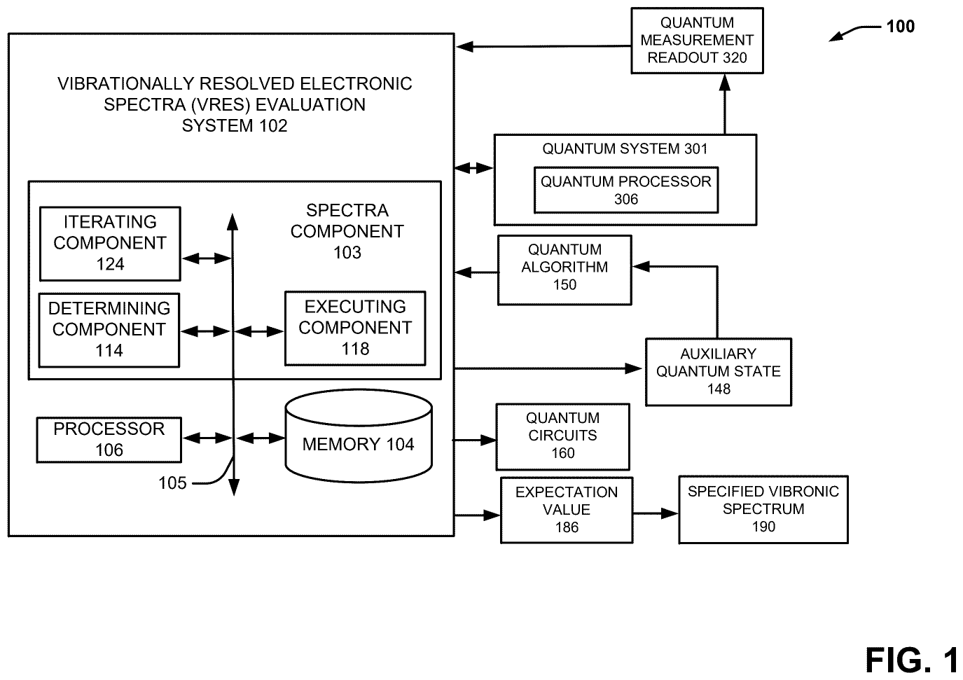

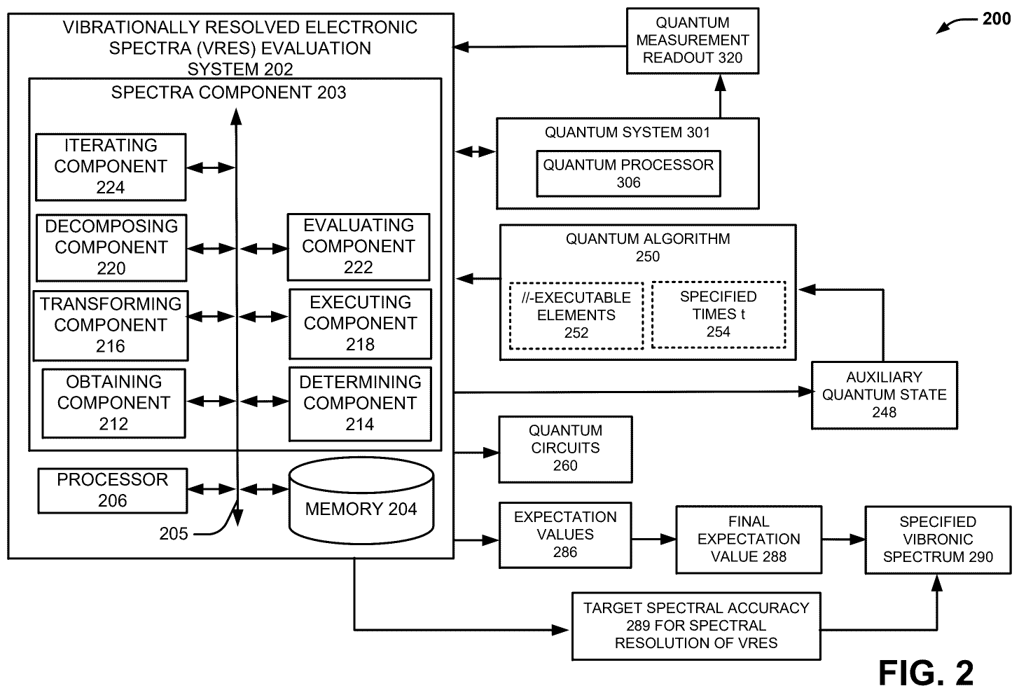

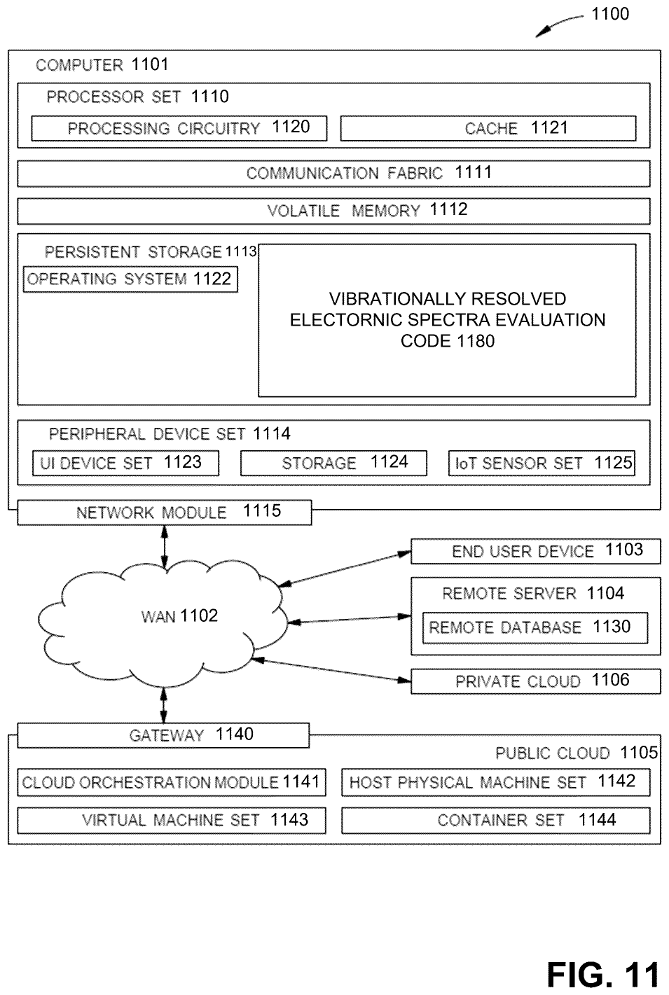

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1100 illustrated at FIG. 11. In one or more described embodiments, computer and/or computing-based elements can be used in connection with implementing one or more of the systems, devices, components and/or computer-implemented operations shown and/or described in connection with FIGS. 1 and/or 2 and/or with one or more other figures described herein.

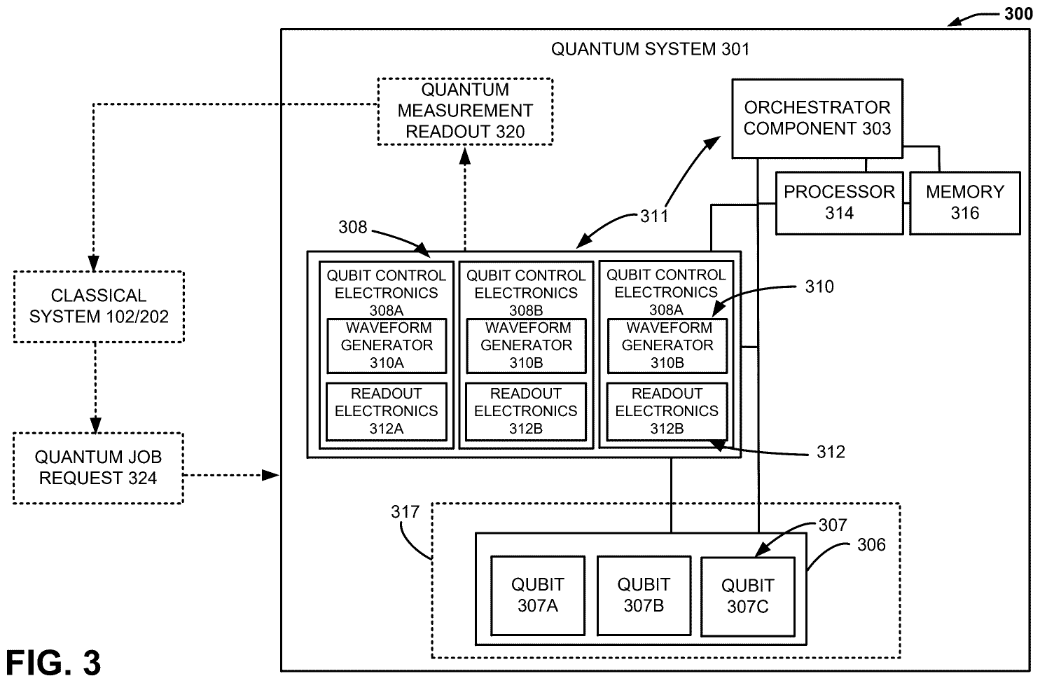

Turning now in particular to one or more figures, and first to FIG. 1, the figure illustrates a block diagram of an example, non-limiting system 100 that can provide determination of a specified vibronic spectrum 190 of a molecule using both a classical vibrationally resolved electronic spectrum (VRES) evaluation system 102 and a quantum system 301 (FIG. 3).

That is, the non-limiting system 100 can comprise the VRES evaluation system 102 and the quantum system 301, to be described in detail below. It is noted that the VRES evaluation system 102 is only briefly described relative to FIG. 1 to provide but a lead-in to description of a more complex and/or more expansive vibrationally resolved electronic spectrum (VRES) system 202 as illustrated at FIG. 2. Further detail regarding processes that can be performed by one or more embodiments described herein will be provided below relative to the non-limiting system 200 of FIG. 2.

Still referring to FIG. 1, the VRES evaluation system 102 can comprise at least a memory 104, bus 105, processor 106, determining component 114, executing component 118 and/or iterating component 124. Using these components and the quantum system 301, the VRES evaluation system 102 can provide for generation of a multi-element quantum algorithm 150 for being executed as a set of quantum circuits 160 at the quantum system 301, employed the quantum processor 306, and resulting in an expectation value 186 that can be employed to derive/generate the specified vibronic spectrum 190, whether in a computer-readable data format, user entity-readable data format, and/or in a graphed, visual format.

Generally, the determining component 114 can determine a non-arbitrary auxiliary quantum state 148 to be prepared at the quantum system 301 in correlation with execution of the quantum algorithm 150 that represents an autocorrelation function a(t) corresponding to a specified vibronic spectrum 190 (e.g., to an associated Franck-Condon profile). The auxiliary quantum state 148 is non-arbitrary to prevent exponential decay with a number of qubits 307 of the quantum system 301 employed for various elements of the quantum algorithm 150, and to prevent exponential indistinguishability various elements of the quantum algorithm 150 from one another, as will be explained below in greater detail relative to FIG. 2 (also applicable to the embodiment of FIG. 1).

In response to the determining of the auxiliary quantum state 148 the executing component 118 generally can obtain a set of measurements (e.g., quantum measurement readouts 320) corresponding to the autocorrelation function a(t) by controlling an execution of the quantum algorithm 150 based on the non-arbitrary auxiliary quantum state 148 as an initial qubit state for the quantum system 301.

In one or more embodiments, the determining component 114 and/or the executing component 118 can be implemented independently, without the other of the determining component 114 and/or the executing component 118. Additionally and/or alternatively, the determining component 114 and/or the executing component 118 can be comprised by a high-level spectra component 103, the high-level spectra component 103 can perform one or more of the above-described functions of the determining component 114 and/or the executing component 118, and/or the determining component 114 and/or the executing component 118 can be omitted with the high-level spectra component 103 performing one or more of the above-described functions of the omitted determining component 114 and/or the executing component 118.

In general, the non-limiting system 100 can employ any suitable method of communication (e.g., electronic, communicative, internet, infrared, fiber, etc.) to provide communication between the classical system 102 and the quantum system 301.

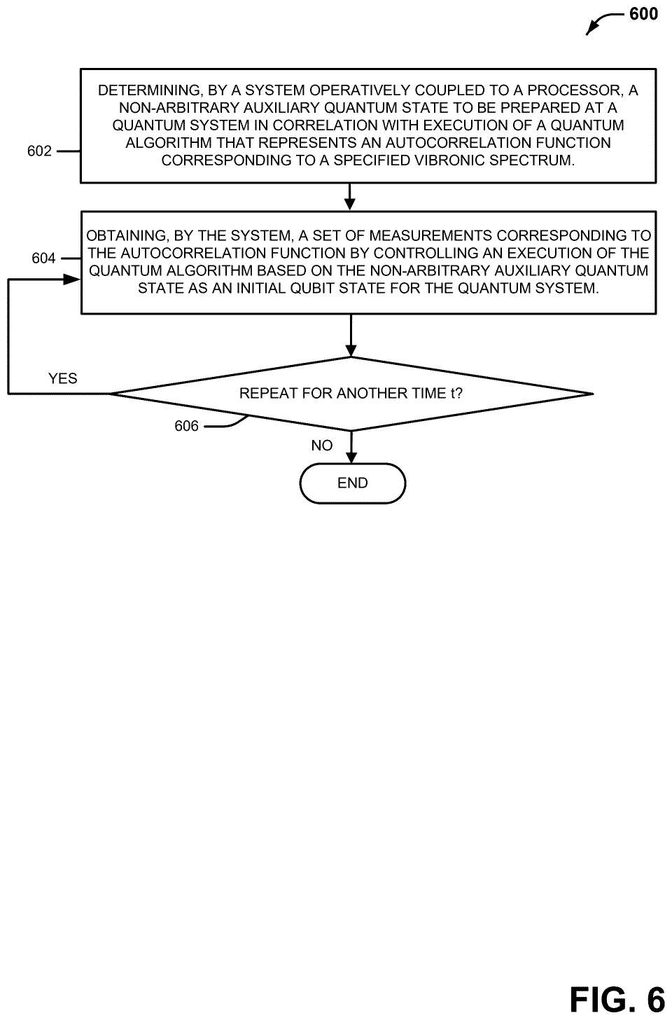

As a summary, referring next briefly to FIG. 6, illustrated is a flow diagram of an example, non-limiting method 600 that can provide a process to determine a specified vibronic spectrum 190 for a molecule, in accordance with one or more embodiments described herein, such as the non-limiting system 100 of FIG. 1. Repetitive description of like elements and/or processes employed in respective embodiments is omitted for sake of brevity.

At 602, the non-limiting method 600 can comprise determining, by a system operatively coupled to a processor (e.g., determining component 114 coupled to processor 106), a non-arbitrary auxiliary quantum state (e.g., non-arbitrary auxiliary quantum state 148) to be prepared at a quantum system (e.g., quantum system 301) in correlation with execution of a quantum algorithm (e.g., quantum algorithm 150) that represents an autocorrelation function (e.g., a(t)) corresponding to a specified vibronic spectrum (e.g., specified vibronic spectrum 190).

At 604, the non-limiting method 600 can comprise obtaining, by the system (e.g., executing component 118), a set of measurements (e.g., quantum measurement readouts 320) corresponding to the autocorrelation function by controlling an execution of the quantum algorithm based on the non-arbitrary auxiliary quantum state as an initial qubit state for the quantum system.

At 606, the non-limiting method 600 can comprise determining, by the system (e.g., iterating component 124), whether execution at the quantum system is to be repeated for an additional time t. If yes, the non-limiting method 600 can proceed back to step 604. In one or more embodiments, the non-limiting method 600 can alternatively proceed back to step 602 to further prepare a different non-arbitrary auxiliary quantum state in connection with the additional time t. If not, the non-limiting method 600 can end.

Turning next to FIG. 2, a non-limiting system 200 is illustrated that can comprise a VRES evaluation system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 can facilitate determination of a specified vibronic spectrum 290 (also herein referred to as a vibrationally resolved electronic spectrum) of a molecule using both a classical vibrationally resolved electronic spectra (VRES) evaluation system 202 and the quantum system 301 (FIG. 3).

Turning first to the VRES evaluation system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The VRES evaluation system 202 can be associated with, such as accessible via, a cloud computing environment.

The VRES evaluation system 202 can comprise a plurality of components. The components can comprise a memory 204, processor 206, bus 205, obtaining component 212, determining component 214, transforming component 216, executing component 218, decomposing component 220, evaluating component 222 and/or iterating component 224. Using these components, and using operation of the quantum system 301, the non-limiting system 200 generally can provide one or more quantum measurement readouts 320 that can be employed, by the one or more embodiments, to determine one or more expectation values 286, which in turn can be employed, by the one or more embodiments, to determine the specified vibronic spectrum 290, whether in a computer-readable data format, user entity-readable data format, and/or in a graphed, visual format.

That is, the obtaining component 212, determining component 214, transforming component 216, executing component 218, decomposing component 220, evaluating component 222 and/or iterating component 224 can operate at the classical system 202 of the non-limiting system 200. One or more quantum circuits (e.g., quantum circuits 260) can be executed by the quantum system 301. In one or more other embodiments, one or more processes performed by any one or more of the obtaining component 212, determining component 214, transforming component 216, executing component 218, decomposing component 220, evaluating component 222 and/or iterating component 224 can be performed at the quantum system 301.

Discussion first turns briefly to the processor 206, memory 204 and bus 205 of the VRES evaluation system 202. For example, in one or more embodiments, the VRES evaluation system 202 can comprise the processor 206 (e.g., computer processing unit, microprocessor, classical processor, quantum processor and/or like processor). In one or more embodiments, a component associated with VRES evaluation system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the obtaining component 212, determining component 214, transforming component 216, executing component 218, decomposing component 220, evaluating component 222 and/or iterating component 224.

In one or more embodiments, the VRES evaluation system 202 can comprise the computer-readable memory 204 that can be operably connected to the processor 206. The memory 204 can store computer-executable instructions that, upon execution by the processor 206, can cause the processor 206 and/or one or more other components of the VRES evaluation system 202 (e.g., obtaining component 212, determining component 214, transforming component 216, executing component 218, decomposing component 220, evaluating component 222 and/or iterating component 224) to perform one or more actions. In one or more embodiments, the memory 204 can store computer-executable components (e.g., obtaining component 212, determining component 214, transforming component 216, executing component 218, decomposing component 220, evaluating component 222 and/or iterating component 224).

The VRES evaluation system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the VRES evaluation system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the VRES evaluation system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the VRES evaluation system 202 and the quantum system 301.

In addition to the processor 206 and/or memory 204 described above, the VRES evaluation system 202 can comprise one or more computer and/or machine readable, writable and/or executable components and/or instructions that, when executed by processor 206, can provide performance of one or more operations defined by such component and/or instruction.

Discussion next turns to the additional components of the VRES evaluation system 202 (e.g., obtaining component 212, determining component 214, transforming component 216, executing component 218, decomposing component 220, evaluating component 222 and/or iterating component 224).

First, it is noted that in one or more embodiments, the obtaining component 212, determining component 214, transforming component 216, executing component 218, decomposing component 220, evaluating component 222 and/or iterating component 224 can be implemented independently, without one or more other of the obtaining component 212, determining component 214, transforming component 216, executing component 218, decomposing component 220, evaluating component 222 and/or iterating component 224. Additionally and/or alternatively, the obtaining component 212, determining component 214, transforming component 216, executing component 218, decomposing component 220, evaluating component 222 and/or iterating component 224 can be comprised by a high-level spectra component 203, one or more of the below-described functions of the obtaining component 212, determining component 214, transforming component 216, executing component 218, decomposing component 220, evaluating component 222 and/or iterating component 224 can be performed by the high-level spectra component 203, and/or the obtaining component 212, determining component 214, transforming component 216, executing component 218, decomposing component 220, evaluating component 222 and/or iterating component 224 can be omitted with the high-level spectra component 203 performing one or more of the below-described functions of the one or more omitted obtaining component 212, determining component 214, transforming component 216, executing component 218, decomposing component 220, evaluating component 222 and/or iterating component 224.

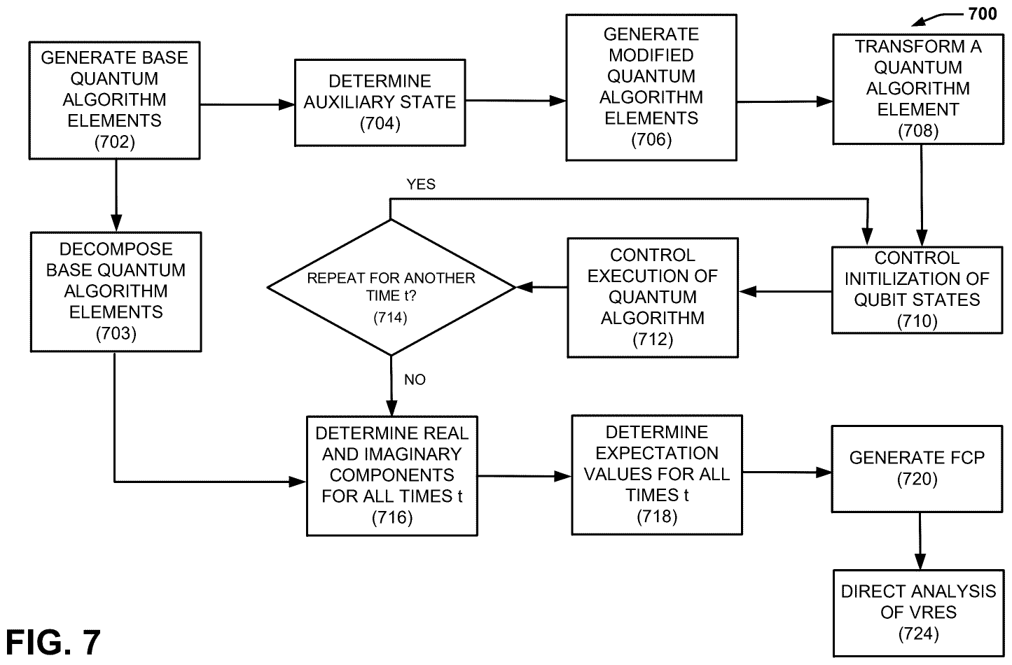

Direction now turns to FIG. 7, illustrating a schematic 700 of processes that can be performed by the VRES evaluation system 202, and also still to FIG. 2. Referring specifically to the obtaining component 212, the obtaining component 212 generally can find, locate, determine, request, download, read and/or otherwise obtain information (e.g., data and/or metadata) relating to a request for VRES determination and/or relative to a molecule of interest, such as for which determination of a specified vibronic spectrum 290 is requested. Likewise, the obtaining component 212 can find, locate, determine, request, download, read and/or otherwise obtain information (e.g., data and/or metadata) relating to various quantum algorithm aspects, such as corresponding quadratic equations (e.g., also herein referred to as elements of a quantum algorithm), and/or information related to the physical qubits of the quantum processor 306 (e.g., a physical qubit hardware mapping). This obtaining can provide background, givens and/or information to employ a rotation-based approach for determination of a Franck-Condon profile.

That is, the one or more embodiments described herein find basis in a Born-Oppenheimer approximation where

$${H}_{mol} = {\sum }_{S} \vert {ψ}_{s} > < {ψ}_{s} \vert ⊗ ( \frac{{p}^{2}}{2} + {V}_{s} ( q ) ) ,$$

wherein absorption of light leads to excitation of an electronic state |ψ₀>→|ψ₁>, and based on an instantaneous change of a nuclear part of the respective Hamiltonian, where

$${H}_{nuc}^{0} = \frac{{p}^{2}}{2} + {V}_{0} ( q ) \to {H}_{nuc}^{1} = \frac{{p}^{2}}{2} + {V}_{1} ( q ) .$$

In correspondence with the above-noted assumptions, a rotation-based approach for determination of a Franck-Condon profile does not require a controlled unitary and is based on a fact that quantities such as Equation 0: |a(t)|²≡| [symbol] 0|e^{-iHt}|0 [symbol] |² can be efficiently measured on quantum hardware by measuring probability to measure a second state |0 [symbol] ^{ϑL}(e.g., a state of all zeroes) after preparing a first state e^{-iHt}|0 [symbol] , where a(t) is an autocorrelation function corresponding to a specified vibronic spectrum 290. However, to calculate the Franck-Condon profile, the full autocorrelation function a(t) (e.g., based on both its imaginary components and its real components) is needed, and not just an absolute value of a(t), as determinable at Equation 0.

To accomplish this determination, the autocorrelation function a(t) is calculated classically by the VRES evaluation system 202, using quantum computing input. That is, a(t) is calculated by obtaining (by the classical VRES evaluation system 202) quantum measurement readouts 320 (output by a quantum system 301) for a range of specified times t (254) and then classically calculating (by the classical VRES evaluation system 202) a Fourier transform of the autocorrelation function a(t). To accomplish this, time t and frequency ω are discretized to set up a time and frequency grid (or to obtain data/metadata corresponding to a frequency grid, without direct construction of the frequency grid), the values of which can be denoted by t_{gr} and ω_{gr}, noting that t_{gr} is inversely proportional to the ω_{gr}. The discrete frequencies ω_{gr} can be discretized linearly between the lowest and highest harmonic frequencies. It is noted that since anharmonic frequencies lie below their harmonic counterparts, the grid determination using this approach can ensure that anharmonic frequencies are included.

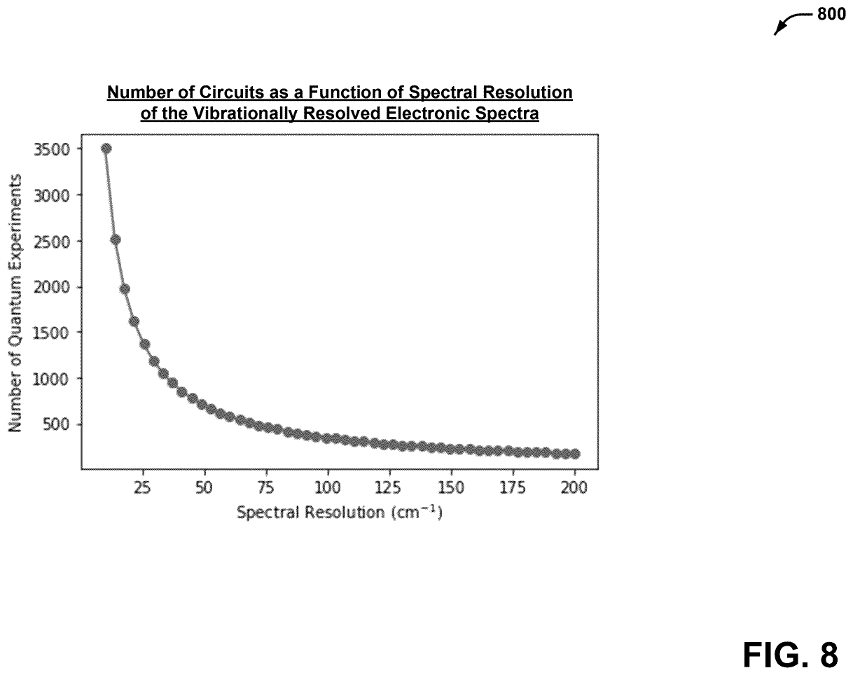

Looking to FIG. 8, providing a visualization of such frequency grid 800, a number of grid points N can be inversely proportional to a target spectral accuracy 289, i.e. N scales as O(1/(Δω)). O is a notation referring to scaling behavior of a quantity in some limit, where here the limit in question is when N is large and (1/(Δω)) is small, respectively. For each value of time in the t_{gr} the quantum algorithm 250 can be determined (by the classical VRES evaluation system 202) and executed (at the quantum system 301 via control by/direction by the VRES evaluation system 202). The auto-correlation function a(t) can subsequently be calculated at each specified time t 254 (using the classical VRES evaluation system 202 based on outputs of the quantum system 301).

Accordingly, looking to Equation 1 below, to determine the full autocorrelation function a(t), and not just its absolute value, σ(ω) is the quantity that can be sought, where generally, σ(ω) can be represented by a Fourier transform of a(t) (e.g., the Fourier transform of a(t), and thus σ(ω) representing the Franck-Condon profile). Here, σ is a frequency corresponding to that of the light/energy source absorbed by a molecule/quantum system in question. Certain values of omega, referred to as σᵢ, correspond to resonance peaks of the quantum system in question.

$$σ ( ω ) = {\int }_{∞}^{∞} {e}^{iωt} 〈 {ψ}_{0} \vert {e}^{- iHt} \vert {ψ}_{0} 〉 dt = F ( 〈 {ψ}_{0} \vert {ψ}_{t} 〉 ) = F ( a ( t ) ) , \qquad Equation l$$

wherein H refers to Hamiltonian, i refers to the conventional complex number i, t is a specified time 254 of the autocorrelation function a(t), ω is frequency (e.g., frequency corresponding o that of the light/energy source absorbed by the molecule/quantum system in question), and ψ is an initial qubit state of a quantum system. In practice, this state can be prepared on qubits, by a quantum system, as a product state.

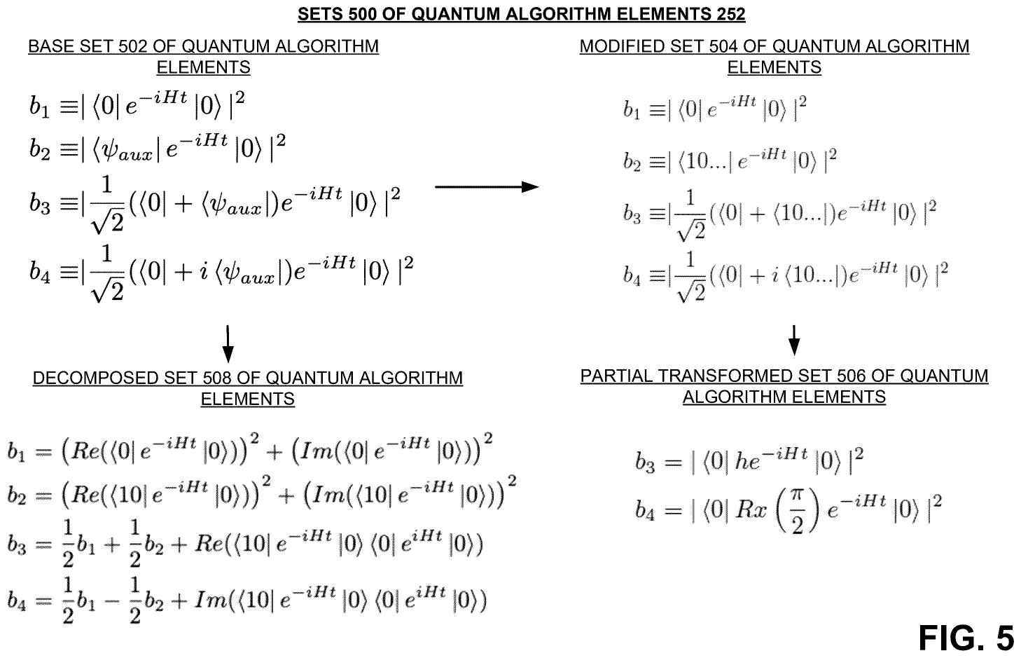

Accordingly, a first state |10 . . . [symbol] ≡|1 [symbol] ⊗|0 [symbol] ^{⊗L-1} can be considered, where L is a number of qubits, with the obtaining component 212 obtaining and/or the determining component 214 generating a base set 502 (FIG. 5) of quantum algorithm elements 252 for use in determining these real and imaginary components of the autocorrelation function a(t), e.g., of the Franck-Condon profile, at step 702 (FIG. 7).

### Base Set 502 of Quantum Algorithm Elements 252

$${{{b}_{1} ≡ {\vert 〈 0 \vert {e}^{- iHt} \vert 0 〉 \vert}^{2} {b}_{2} ≡ {\vert 〈 {ψ}_{aux} \vert {e}^{- iHt} \vert 0 〉 \vert}^{2} {b}_{3} ≡ \vert \frac{1}{\sqrt{2}} ( 〈 0 \vert + 〈 {ψ}_{aux} \vert ) {e}^{- iHt} \vert 0 〉 \vert}^{2} {b}_{4} ≡ \vert \frac{1}{\sqrt{2}} ( 〈 0 \vert + i ( {ψ}_{a ι ι x} \vert ) {e}^{- iHt} \vert 0 〉 \vert}^{2}$$

In these equations, H refers to Hamiltonian, i refers to the conventional complex number i and t is a specified time 254 of the autocorrelation function a(t). These equations are quadratic equations that together can be referred to as a quantum algorithm 250 and also together can be parallelly-executable at the quantum system 301 to provide for execution of the quantum algorithm 250. As will be described below, and as is illustrated at FIG. 5 showing various sets of the quantum algorithm elements 252, these quantum algorithm elements 252 can have various forms, be transformed, be decomposed, etc. to provide for different quantities. In doing so, each quantity can remain equal to others of the same quantity (e.g., b₁ remaining equal to other b₁, etc.). The term “parallelly-executable” can refer to ability of the various elements to be executed in parallel (e.g., at least one in being performed at least partially in parallel with at least one other). It is noted that the parallel execution is option. Regardless, all four quantities/elements 252 can be executed at the quantum system 301 to provide for full execution of the quantum algorithm 250 and to allow for output of corresponding quantum measurement readouts 320. This can subsequently allow for determination of associated expectation values, associated real components and imaginary components, and the associated Franck-Condon profile.

The quantities b₁ to b₄ can be ultimately calculated using classical calculation based on the measurement readouts 320 from quantum hardware execution. To do so, the base set 502 with ψₐᵤₓ being blank can be default equations employed by the obtaining component 212 and/or determining component 214 from a suitable storage medium. That is, as noted above, these default quadratic equations provided as the base set 502 are based on the Born-Oppenheimer approximation, in correspondence with the assumptions noted relative to Equation 0.

Regarding determination of ψₐᵤₓ, a quantum state other than |0 . . . 0> can be used for ψₐᵤₓ. One example is the state 10 . . . 0>, chosen because it can be easy to prepare. Generally, the determining component 214 can be directed to select ψₐᵤₓ such that the measured quantities b₁ to b₄ are large enough to be measured, where the exact threshold required can depend on the operating parameters of the quantum system 301 being employed.

Put another way, the auxiliary quantum state 248 can be generated by the determining component 214 (step 704), based on satisfactory conditioning of the base set 502 of quantum algorithm elements 252 using the auxiliary quantum state 248 as an initial quantum state for one or more qubits 307 at the quantum system 301. For example, both the state |ψₐᵤₓ [symbol] and the state (√½)(|ψₐᵤₓ [symbol] +|0 [symbol] ) can be efficiently prepared on quantum hardware. Generally, the state |ψₐᵤₓ [symbol] can be determined to be a non-arbitrary state, such as comprising 0 and 1 states for initial qubit states for qubits 307 being employed for execution of the different quantum algorithm elements 252. In this way, by determining initial qubit states of majoritively 0 states, with a limited number of 1 states, initialization of quantum hardware for execution of quantum circuits 260 corresponding to the base set 252 of quantum algorithm elements 252 can be executed with minimal time, cost, power, depth of circuits, etc. Indeed, 0 states can typically be the ground states of qubits 307 being employed, with 1 states being easily obtained by one or more operations at the quantum system 301. This ease of initialization can provide a large benefit over existing approaches for vibronic spectra determination. For example, the auxiliary quantum state 248 can be employed allowing for omission of use of any controlled unitary during the quantum hardware execution.

It is noted that numerical stability of the rotation method described herein can be at least partially based upon the auxiliary quantum state 248 being determined as a non-arbitrary auxiliary quantum state 248. That is, a purely arbitrary auxiliary quantum state can cause b₂ to decay exponentially with the number of respective qubits to be employed, and/or b₃ and/or b₄ can become exponentially indistinguishable from b₁. Accordingly, the determining component 214 can determine the auxiliary quantum state 248 as being well-conditioned, and thus not causing this undesired scaling behavior.

Further, solving these quadratic equations b₁ to b₄ numerically on a classical computer can be challenging, particularly where the quantities involved are too small (e.g. when b₁ to b₄ are less than the value of the precision of a floating point number). If this is the case, the determining component 214, and/or a user entity can direct, selection of a different ψₐᵤₓ.

Additionally, it is noted that the auxiliary quantum state 248 is the same for each quantum algorithm element 252 of a set of b₁ to b₄. Further, in one or more embodiments, the selected auxiliary quantum state 248 (|ψₐᵤₓ [symbol] ) employed for various sets of quantum algorithm elements 252 of b₁ to b₄ to each time t being employed. It is also noted that in one or more embodiments, the non-arbitrary auxiliary state 248 can be re-determined (e.g., can be different) for different specified times t 254. That is, the quantity a(t) is independent of the choice of auxiliary state 248. Thus, the determining component 214 can re-determine the non-arbitrary auxiliary state 248 for one or more additional sets of algorithm elements 252 of b₁ to b₄.

Based on these determinations, including that of the non-arbitrary auxiliary state 248, the determining component 214 can generate a modified set 504 of quantum algorithm elements 252 (step 706), the form of which can be better employed at the quantum system 301. As noted above, the modification of these quantum algorithm elements 252 of b₁ to b₄ is based on insertion of a selected ψₐᵤₓ in place of a blank ψₐᵤₓ.

### Modified Set 504 of Quantum Algorithm Elements 252

$${{{b}_{1} ≡ {\vert 〈 0 \vert {e}^{- iHt} \vert 0 〉 \vert}^{2} {b}_{2} ≡ {\vert 〈 10 … \vert {e}^{- iHt} \vert 0 〉 \vert}^{2} {b}_{3} ≡ \vert \frac{1}{\sqrt{2}} ( 〈 0 \vert + 〈 10 … \vert ) {e}^{- iHt} \vert 0 〉 \vert}^{2} {b}_{4} ≡ \vert \frac{1}{\sqrt{2}} ( 〈 0 \vert + i ( 10 … \vert ) {e}^{- iHt} \vert 0 〉 \vert}^{2}$$

For example, b₁ and b₂ can be calculated on quantum hardware (e.g., quantum system 301) by measuring probability of observing states |0 [symbol] and |10 . . . [symbol] , respectively. With regards to Equation 2, below, then quantities b₃ and b₄ can be likewise calculated on quantum hardware by measuring probability of observing the state |10 . . . [symbol] .

$${\vert {ψ}_{aux} 〉 = \vert 10 …0 〉 ≡ \vert 1 〉 ⊗ \vert 0 〉}^{⊗ L - 1} . \qquad Equation 2$$

In particular, quantities b₃ and b₄ can be measured on the quantum hardware of a quantum system (e.g., quantum system 301) by observing that these quantities can be transformed. For example, the transforming component 216 can transform at least one equation of the modified set 504 of four quantum algorithm elements 252 into a transformed quadratic equation comprising a rotation gate about a corresponding x-axis. Put another way, the transforming component 216 can transform the quantities b₃ and b₄ into a partial set 506 (FIG. 5) of two quantum algorithm elements 242, e.g., at step 708.

### Partial Transformed Set 506 of Quantum Algorithm Elements 252

$${b}_{3} = {\vert 〈 0 \vert {he}^{- iHt} \vert 0 〉 \vert}^{2} \\ {b}_{4} = {\vert 〈 0 \vert Rx ( \frac{π}{2} ) {e}^{- iHt} \vert 0 〉 \vert}^{2}$$

In this partial set of quadratic equations, h is a Hadamard gate and Rₓ is a rotation gate about the x-axis of the corresponding qubit.

That is, b₃ and b₄ from modified set 504 can be mathematically manipulated by the transforming component 216 to take a form in terms of the Hadamard gate h and the rotation gate Rx, as shown in partial set 506. Partially transformed set 506 shows that b₃ can be measured as the probability of measuring the state |0 . . . 0> after the application of e\hat{ }{−iHt} followed by the Hadamard gate h on the initial state |0 . . . 0>. Similarly, partial set 506 shows that b₄ can be measured as the probability of measuring the state |0 . . . 0> after the application of e\hat{ }{−iHt} followed by the gate Rx(pi/2) on the initial state |0 . . . 0>.

That is, the quantities b_{3-modified} and b_{4-modified} in 504 are the same quantities as b₃-transformed and b_{4-transformed} in the partial transformed set 506. The purpose of illustrating the transformed set 506 is to illustrate explicitly that b₃ and b₄ can be measured as the probabilities of measuring the state |0 . . . 0> after the action of e\hat{ }{−iHt} and Rx(pi/2) e\hat{ }{−iHt} respectively. Indeed, modified set 504 is still being solved, however partially transformed set 506 demonstrates the quantities b₃ and b₄ can be employed on quantum hardware, such as of quantum system 301.

It is noted that FIG. 5 illustrates the various sets 500 of quantum algorithm elements 252 in a single illustration for ease of reference. That is, turning briefly to FIG. 5, in addition to still referring to FIG. 2, provided is an illustration of the various sets 500 of quantum algorithm elements 252 that can be employed and/or generated by the VRES evaluation system 202 relative to a set of quantum circuits 260 to be executed to determine the one or more expectation values 286, and thus to determine the real and imaginary components of the autocorrelation function a(t).

Regarding FIG. 5, as described both above and below, a base set 502 of quantum algorithm elements 252 can be modified by the VRES evaluation system 202 resulting in a modified set 504 of quantum algorithm elements 252. At least a portion of the modified set 504 of quantum algorithm elements 252 can be further transformed into the partial transformed set 506 of quantum algorithm elements 252. Based on the modified set 504 of quantum algorithm elements 252 and on the partial transformed set 506 of quantum algorithm elements 252, full corresponding quantum algorithms 250 and quantum circuits 260 determined therefrom (e.g., by the executing component 218) can controlled to be executed at the quantum system 301, by the VRES evaluation system 202. Using the results of the corresponding executions at the quantum system, and using the decomposed set 508 of quantum algorithm elements 252 (based on the base set 502 of quantum algorithm elements 252), the VRES evaluation system 202 can determine the one or more expectation values 286. Based thereon, the VRES evaluation system 202 can define a Franck-Condon profile for a specified vibrationally-resolved electronic spectrum.

Accordingly, turning back to FIG. 2, based on the modified set 504 of quantum algorithm elements 252 and on the partial transformed set 506 of quantum algorithm elements 252, various measurements for determining the quantities b₁ to b₄ can be obtained as respective quantum measurement readouts 320 from the quantum system 301, relative to respective quantum circuits 260 to be executed. In one or more embodiments, the executing component 218 can generate one or more of the respective quantum circuits 260, as is conventionally understood by one have ordinary skill in the art.

In one or more embodiments, the executing component 218 can control preparation of the auxiliary quantum state 248, for the respective time t, at the quantum system 301 (step 710). This can involve sending one or more quantum job requests 324 to the quantum system 301, including data/metadata defining the quantum algorithm 250/quantum circuits 260 to be executed. Likewise, the executing component 218 can control execution of the respective quantum circuits 260 at the quantum system 301 (step 712), allowing for calculation of b_{1-modified}, b_{2-modified}, b_{3-transformed} and b_{4-transformed} and output of respective measurements (e.g., based on respective quantum measurement readouts 320) corresponding to these quantities. Put another way, much more generally, the executing component 218 can generally control execution of a set of respective quantum algorithm elements 252 of sets 504/506 at the quantum system 301.

Next, prior to discussion of use of the quantum measurement readouts 320, discussion first turns to a general description of an exemplary quantum system 301 that can be operated to provide execution of the quantum circuits 260 and provision of the quantum measurement readouts 320 in connection with the classical system 202.

Turning to FIG. 3, one or more embodiments described herein can include one or more devices, systems and/or apparatuses that can provide a process to generate one or more waveforms or pulses for a quantum-based operation (e.g., using a quantum device), such as for operating one or more qubits of a quantum device. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100 and/or 200.

As illustrated at FIG. 3, the non-limiting system 300 can comprise a quantum system 301 that can be employed with the classical systems 102/202 or separate from the classical systems 102/202.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high-level components and/or functions. The quantum circuitry can generate physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readouts 320, can be responsive to a quantum job request 324 and associated input data, which can be based at least in part on the input data, quantum functions and/or quantum computations (e.g., here comprising requested execution of quantum circuits 260 based on the quantities b_{1-modified}, b_{2-modified}, b_{3-transformed}, and b_{4-transformed}).

In one or more embodiments, the quantum system 301 can comprise components, such as an orchestrator component 303, a quantum processor 306, pulse component (e.g., a waveform generator 310) and/or a readout electronics 312 (e.g., readout component).

The quantum processor 306 can comprise one or more, such as plural, qubits 307. Individual qubits 307A, 307B and 307C, for example, can be fixed frequency and/or single junction qubits, such as transmon qubits.

In one or more embodiments, a readout resonator can be associated with, such as located with physical hardware defining a qubit 307.

In one or more embodiments, a memory 316 and/or processor 314 can be associated with the orchestrator component 303, where suitable. The processor 314 can be any suitable processor. The processor 314 can generate one or more instructions for controlling the one or more processes of the orchestrator component 303, such as for controlling one or more subordinate controllers (e.g., qubit control electronics 308).

The orchestrator component 303 can obtain (e.g., download, receive, search for and/or the like) a quantum job request 324 requesting execution of one or more quantum programs and/or requesting a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical systems 102/202.

The orchestrator component 303 can determine mapping of one or more quantum logic circuits for executing a quantum program based on the quantum job request 324. In one or more embodiments, the orchestrator component 303 and/or quantum processor 306 can control the waveform generator 310 to generate one or more pulses, tones, waveforms and/or the like to affect one or more qubits 307, such as in response to the quantum job request 324.

In one or more embodiments, more than one orchestrator component 303 can be comprised by the quantum system 301. The one or more orchestrator components 303 can be employed to control one or more qubit control electronics 308. Thus, the one or more qubit control electronics 308A, 308B and/or 308C can be communicatively coupled to the one or more orchestrator components 303.

Qubit control electronics 308 can be employed by the quantum processor 306 and disposed within a room temperature environment external to the cryogenic environment 317, as illustrated. In one or more embodiments, one or more aspects of one or more qubit control electronics can be disposed within a cryogenic environment 317.

In one or more embodiments a qubit control electronics 308 can be provided per qubit 307. In one or more embodiments, a qubit control electronics 308 can be provided to communicate with more than one qubit 307 per that qubit control electronics 308.

In one or more embodiments, a qubit control electronics 308 can be and/or can comprise a qubit drive card (e.g., a waveform generator 310) and/or a qubit acquire card (e.g., readout electronics 312). In one or more embodiments, a qubit control electronics 308 can be and/or can comprise only one of a qubit drive card or a qubit acquire card. In one or more embodiments, a qubit control electronics 308 can comprise more than one qubit drive card and/or more than one qubit acquire card.

A waveform generator 310 generally can cause at least one qubit 307 of the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301. Indeed, a signal can be generated by the waveform generator 310 to affect one or more of the plurality of qubits 307.

In one or more embodiments, the waveform generator 310 can control application of such electro-magnetic signal by use of the various qubit control electronics 308.

The quantum processor 306 can be contained in a cryogenic environment, such as generated by a cryogenic environment 317, such as effected by a dilution refrigerator. Where one or more of the plurality of qubits 307 are superconducting qubits, cryogenic temperatures, such as about 4K or lower, can be employed for function of these one or more physical qubits 307.

The readout electronics 312 can comprise and/or be comprised by the acquire card. The readout electronics 312 and/or the acquire card can comprise an analog to digital converter (ADC) 315 that can be employed for the readout path of one or more qubits 307. The readout electronics 312, or at least a portion thereof, can be contained in a room temperature environment or the cryogenic environment 317, such as for reading a state, frequency and/or other characteristic of qubit, excited, decaying or otherwise. Accordingly, one or more elements of the readout electronics 312 also can be constructed to perform at such cryogenic temperatures.

In one or more embodiments, more than one cryogenic environment, such as more than one dilution refrigerator, can be comprised by the quantum system 301.

It is noted that one or more aspects of the aforementioned description can refer to operation of a single set of instructions run on a single qubit controller or set of qubit control electronics. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning now back to FIGS. 2 and 7, in addition to still referring to FIG. 3, discussion turns to one or more additional processes that can be performed by one or more additional components of the VRES evaluation system 202.

For example, at step 714, the iterating component 224 can compare the time t employed for the quantum algorithm elements 502 of sets 504/506 to a list of one or more respective times t for which an expectation value 286 is to be determined. This list can be a default list employed by the VRES evaluation system 202 and/or a list specified by a user entity of the VRES evaluation system 202.

In one or more embodiments, the iterating component 224 can determine the specified times t 254. For example, referring to further detail of graph 800 at FIG. 8, graphically illustrated is a number of quantum experiments to perform at the y-axis (e.g., number of different t factors employed) as a function of spectral resolution of a specified vibronic spectrum 290. As illustrated, a target spectral resolution 289 of 50 cm⁻¹ can be achieved with an acceptable number of quantum experiments (e.g., number of quantum algorithms 250 to execute) numbering between 500 and 1000. The target spectral resolution 289 is presently defined as an industry accepted spectral resolution.

Using data corresponding to the discretization of times t and frequencies ω, as illustrated at graph 800, the iterating component 224 can determine a set of specified times t 254. It is noted that since anharmonic frequencies lie below their harmonic counterparts, the data determination using this approach, as additionally described above also relative to FIG. 8, can ensure that anharmonic frequencies are included.

Put another way, default target accuracies 289 can be specified, such as by a user entity using a device communicatively couplable to the VERS evaluation system 202, for the frequencies ω. By employing known scaling behavior of the quantities b₁ to b₄, sizes of the discrete time steps, corresponding to the specified times t 254 to be selected, can be calculated by the user entity and/or by the iterating component 224, relative to the understanding described above, that a number of grid points N can be inversely proportional to a target spectral accuracy 289, i.e. N scales as O(1/(Δω)), where O is a notation referring to scaling behavior of a quantity in some limit, and where here the limit in question is when N is large and (1/(Δω)) is small, respectively. The specified values of t 254 can then be determined by the user entity or automatically by the iterating component 224 by evenly spacing a specified full time window into the discrete steps. In one or more embodiments of use, a number of quantum experiments to be employed (e.g., a number of quantum algorithms 250 to be employed) is equal to the number of time steps (see, e.g., the y-axis of graph 800 of FIG. 8, as an illustrated reference.

It is noted that a similar graph for a conventional framework, such as using quantum phase estimation, would instead employ “number of control qubits” as a y-axis unit, and thus quantity of executions would be significantly increased across the board, regardless of spectral resolution, as compared to the one or more frameworks described herein. Further, the approximations regarding a Hilbert space taken in conventional approaches can result in resonance peaks of an associated spectra not being within 50 cm⁻¹ of the true peaks for the molecule of interest, but rather being shifted.

Accordingly, based on a comparison by the iterating component 224 of the specified times t 254 performed versus those not yet performed, the iterating component 224 can determine if one or more processes performed by the VRES evaluation system 202 should be repeated for one or more additional times t. If one or more additional times t remain that have not been employed, the iterating component 224 can perform one or more processes. These one or more processes can comprise, in one or more embodiments, control of the determining component 214 to determine another auxiliary state 248 relative to another time t. In one or more embodiments, a same auxiliary state 248 can be employed for two or more times t. The one or more processes additionally and/or alternatively can comprise control of the executing component 218 to control initialization of the next auxiliary state 248 (whether being a new state or a same state) and/or to control corresponding execution of another quantum algorithm 250, comprising sub-executions of another set of four quantum algorithm elements 252 of sets 504/506, based on the another time t. Separate from the processes controlled by the executing component 218, the decomposing component 220 can control decomposition of the base set 502 of quantum algorithm elements 252, for each time t employed, into a respective decomposed set 508 of quantum algorithm elements 252 based on the real and imaginary parts of the autocorrelation function a(t) (step 703).

### Decomposed Set 508 of Quantum Algorithm Elements 252

$${b}_{1} = {( Re ( 〈 0 \vert {e}^{- iHt} \vert 0 〉 ) )}^{2} + {( Im ( 〈 0 \vert {e}^{- iHt} \vert 0 〉 ) )}^{2} \\ {b}_{2} = {( Re ( 〈 10 \vert {e}^{- iHt} \vert 0 〉 ) )}^{2} + {( Im ( 〈 10 \vert {e}^{- iHt} \vert 0 〉 ) )}^{2} \\ {b}_{3} = \frac{1}{2} {b}_{1} + \frac{1}{2} {b}_{2} + Re ( 〈 10 \vert {e}^{- iHt} \vert 0 〉 〈 0 \vert {e}^{- iHt} \vert 0 〉 ) \\ {b}_{4} = \frac{1}{2} {b}_{1} + \frac{1}{2} {b}_{2} + Im ( 〈 10 \vert {e}^{- iHt} \vert 0 〉 〈 0 \vert {e}^{- iHt} \vert 0 〉 )$$

Using the various quantum measurement readouts 320 relative to the respective decomposed quantum algorithm elements 252 (e.g., using first quantum measurement readouts 320 based on a first time t relative to b_{1-decomposed} also based on first time t, using second quantum measurement readouts 320 based on a second time t relative to s b_{2-decomposed} also based on second time t, and so on), the evaluating component 222 can define the autocorrelation function a(t) in terms of the real components Re and the imaginary components Im based on expectation values 286 corresponding to the set of measurements for the quantities b₁ to b₄, for all times t having been employed (step 716). In one or more embodiments, this can include the evaluating component 222 determining the expectation values 286 based on the quantum measurement readouts 320 (step 718). For example, in one or more embodiments, the executing component 218 can control b₁ to b₄ to be measured by performing a measurement on a same circuit a plurality of times and counting a number of times that the state |0 . . . 0> and |ωₐᵤₓ> are measured respectively.

Using these respective real component Re and imaginary components Im of the autocorrelation function a(t) for all times t, the evaluating component 222 further can aggregate (e.g., combine) the real components and the imaginary components, for each respective time t to determine the autocorrelation function a(t). For example, the evaluating component 222 solving the decomposed set 508 of quantum algorithm elements 252 based on the measurement readouts 320 of the quantum system allows for return of Re and Im. This combination provides all of the information comprised by the autocorrelation function a(t).

Further, the evaluating component 222 can take a Fourier transform of the autocorrelation function a(t), for each different time t employed, resulting in determining σ(ω) and the Franck-Condon profile for the specified vibronic spectrum 290. The information contained in the specified vibronic spectrum 290 can be described as being made up of two parts including the resonance frequencies ω and their corresponding resonance peaks.

As noted above, σ(ω) is the quantity sought, where generally, σ(ω) can be represented by a Fourier transform of a(t) (e.g., the Fourier transform of a(t), and thus σ(ω), both can be stated to represent the Franck-Condon profile). Here, σ is a frequency corresponding to that of the light/energy source absorbed by a molecule/quantum system in question. Certain values of omega, referred to as σᵢ, correspond to resonance peaks of the quantum system in question.

In one or more embodiments, the executing component 218 can direct further analysis of the VRES 290, such as by sending one or more control requests to one or more associated scientific devices that are communicatively coupled to the VRES evaluation system 202.

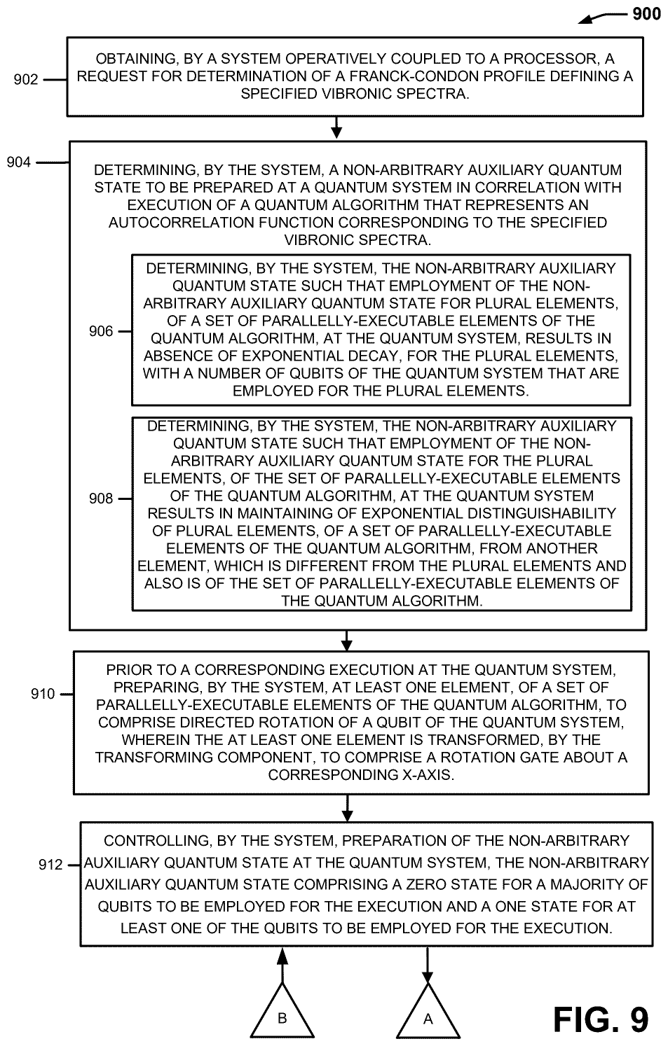

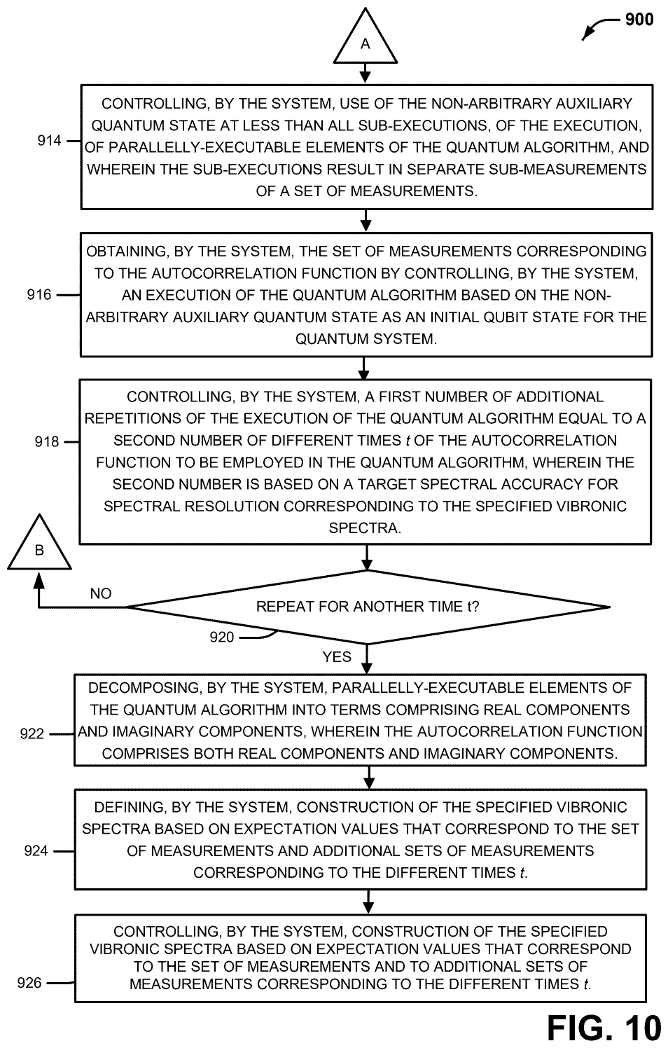

As a summary, referring next to FIGS. 9 and 10, illustrated is a flow diagram of an example, non-limiting method 900 that can provide a process to determine a vibronic spectrum for a specified molecule, in accordance with one or more embodiments described herein, such as the non-limiting system 200 of FIG. 2. While the non-limiting method 900 is described relative to the non-limiting system 200 of FIG. 2, the non-limiting method 900 can be applicable also to other systems described herein, such as the non-limiting system 100 of FIG. 1. Repetitive description of like elements and/or processes employed in respective embodiments is omitted for sake of brevity.

At 902, the non-limiting method 900 can comprise obtaining, by a system operatively coupled to a processor (e.g., obtaining component 212), a request for determination of a Franck-Condon profile defining a specified vibronic spectrum (e.g., specified vibronic spectrum 290).

At 904, the non-limiting method 900 can comprise determining, by the system (e.g., determining component 214), a non-arbitrary auxiliary quantum state (e.g., auxiliary quantum state 248) to be prepared at a quantum system (e.g., quantum system 301) in correlation with execution of a quantum algorithm (e.g., quantum algorithm 250) that represents an autocorrelation function (e.g., a(t)) corresponding to the specified vibronic spectrum.

At 906, step 904 can comprise determining, by the system (e.g., determining component 214), the non-arbitrary auxiliary quantum state such that employment of the non-arbitrary auxiliary quantum state for plural elements (e.g., quantities b₂-b₄), of a set of parallelly-executable elements (e.g., set of parallelly-executable elements 252) of the quantum algorithm, at the quantum system, results in absence of exponential decay, for the plural elements, with a number of qubits (e.g., qubits 307) of the quantum system that are employed for the plural elements.

At 908, step 904 can comprise determining, by the system (e.g., determining component 214), the non-arbitrary auxiliary quantum state such that employment of the non-arbitrary auxiliary quantum state for the plural elements (e.g., quantities b₂-b₄), of the set of parallelly-executable elements of the quantum algorithm, at the quantum system, results in maintaining of exponential distinguishability of the plural elements from another element (e.g., quantity b₁), different from the plural elements and also of the set of parallelly-executable elements of the quantum algorithm.

At 910, the non-limiting method 900 can comprise prior to a corresponding execution at the quantum system, preparing, by the system (e.g., transforming component 216), at least one element (e.g., quantity b₄), of the set of parallelly-executable elements of the quantum algorithm, to comprise directed rotation of a qubit of the quantum system, wherein the at least one element is transformed, by the transforming component, to comprise a rotation gate about a corresponding x-axis (e.g., quantity b₄ of partial transformed set 506 of quantum algorithm elements).

At 912, the non-limiting method 900 can comprise controlling, by the system (e.g., executing component 218), preparation of the non-arbitrary auxiliary quantum state at the quantum system, the non-arbitrary auxiliary quantum state comprising a zero state for a majority of qubits to be employed for the execution and a one state for at least one of the qubits to be employed for the execution.

At 914, the non-limiting method 900 can comprise controlling, by the system (e.g., executing component 218), use of the non-arbitrary auxiliary quantum state at less than all sub-execution, of the execution, of parallelly-executable elements of the quantum algorithm, and wherein the sub-executions result in separate sub-measurements of a set of measurements (e.g., measurement readouts 320).

At 916, the non-limiting method 900 can comprise obtaining, by the system (e.g., executing component 218), the set of measurements corresponding to the autocorrelation function by controlling, by the system (e.g., executing component 218), an execution of the quantum algorithm based on the non-arbitrary auxiliary quantum state as an initial qubit state for the quantum system.

At 918, the non-limiting method 900 can comprise controlling, by the system (e.g., iterating component 224), a first number of additional repetitions of the execution of the quantum algorithm equal to a second number of different times t (e.g., specified times t 254) of the autocorrelation function to be employed in the quantum algorithm, wherein the second number is based on a target spectral accuracy 289 for spectral resolution corresponding to the specified vibronic spectrum.

At 920, the non-limiting method 900 can comprise determining, by the system (e.g., iterating component 224), whether execution at the quantum system is to be repeated for an additional time t. If yes, the non-limiting method 900 can proceed back to at least step 912. If not, the non-limiting method 900 can proceed to step 922.

At 922, the non-limiting method 900 can comprise decomposing, by the system (e.g., decomposing component 220), parallelly-executable elements of the quantum algorithm into terms comprising real components (e.g., Re at the decomposed set 508) and imaginary components (e.g., Im at the decomposed set 508), wherein the autocorrelation function comprises both real components and imaginary components.

At 924, the non-limiting method 900 can comprise defining, by the system (e.g., evaluating component 222), construction of the specified vibronic spectrum based on expectation values (e.g., expectation values 286) that correspond to the set of measurements and to additional sets of measurements corresponding to the different times t. At 926, the non-limiting method 900 can comprise controlling, by the system (e.g., evaluating component 222), construction of the specified vibronic spectrum based on expectation values that correspond to the set of measurements and additional sets of measurements corresponding to the different times t. ADDITIONAL SUMMARY

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system comprising a memory 104, 204 that stores computer executable components, and a processor 106, 206 that executes the computer executable components stored in the memory 104, 204, wherein the computer executable components comprise a determining component 114, 214 that determines a non-arbitrary auxiliary quantum state 148, 248 to be prepared at a quantum system 301 in correlation with execution of a quantum algorithm 150, 250 that represents an autocorrelation function a(t) corresponding to a specified vibronic spectrum 190, 290, and an executing component 118, 218 that obtains a set of measurements 320 corresponding to the autocorrelation function a(t) by controlling an execution of the quantum algorithm 150, 250 based on the non-arbitrary auxiliary quantum state 248 as an initial qubit state for the quantum system 301.

A benefit of the system, computer-implemented method and/or computer program product can be an ability to, during quantum experiment setup, perform an easy initialization of initial states of the qubits being employed in that the quantum circuit executed and/or controlled to be executed by the system, computer-implemented method and/or computer program product employs a ground state of zero or one for each of the qubits being employed. This can allow for quick and efficient preparation for execution of a subsequent quantum algorithm.

Another benefit of the system, computer-implemented method and/or computer program product can be an ability to employ magnitudes fewer gates than conventional frameworks for determining a vibrationally resolved electronic spectrum of a molecule. That is, a number of cycles, a number of qubits employed, a quantum circuit qubit depth, a quantum circuit gate quantity, a quantum circuit gate complexity, a power employed and/or a time employed to determine such vibrationally resolved electronic spectrum can be significantly reduced as compared to conventional frameworks.

Yet another benefit of the system, computer-implemented method and/or computer program product can be a reduction in errors caused and/or assumptions taken to determine the vibrationally resolved electronic spectrum of a molecule, such as in view of lack of use of quantum phase estimation and/or fault tolerancing. In connection therewith, the system, computer-implemented method and/or computer program product can employ a framework that is easily amenable to error mitigation, as compared to conventional frameworks employing quantum phase estimation (QPE) for which error mitigation at a level necessary for determination of vibrationally resolved electronic spectra is not presently possible.

Still another benefit of the system, computer-implemented method and/or computer program product can be an ability for use thereof with industries requiring rapid determination of vibrationally resolved electronic spectra for manufacturing of large quantities of products, such as with respect to spectra of lithium ions relative to battery manufacturing.

Indeed, in view of the one or more embodiments described herein, a practical application of the one or more systems, computer-implemented methods and/or computer program products described herein can be an increased efficiency of determination of values related to vibrationally resolved electronic spectra by providing for more accurate values, such as the expectation values determined herein, by providing a framework employing reduced errors and/or reduced assumptions taken.

Accordingly, the applicant has discovered that employing a rotation-based and time dependent approach to determining vibrationally resolved electronic spectra, as opposed to employing conventional frameworks including quantum phase estimation, can allow for increased accuracy in the resulting determined vibrationally resolved electronic spectra. Furthermore, the use of the one or more frameworks described herein can be employed while providing a consistently achievable resolution of the vibrationally resolved electronic spectrum (such as a 50 cm⁻¹ resolution). As a result, use of the one or more embodiments described herein can allow for reduced and/or more efficient use of a quantum computer as compared to existing frameworks, both due to a reduction in use of controlled unitaries and the easy initialization of qubit initial states.

This result is surprising because it has been traditionally believed that the determination of a vibrationally resolved electronic spectrum would result in acceptance of known errors, use of accuracy-reducing assumptions, and/or use of impossibly-performable error mitigation due to one or more limitations of current-day quantum computers. See, for example, graph 800 at FIG. 8, where the y-axis would be more complexly replaced with “Number of Control/Ancilla Qubits Employed” for use with conventional frameworks (such as employing QPE).

Accordingly, it was unforeseen that employment of a rotation-based time dependent approach could allow for easy and efficient determination of vibrationally resolved electronic spectra while having a low control qubit quantity of one, regardless of molecule for which a vibrationally resolved electronic spectrum is being determined, and while allow for corresponding easy and efficient use of error mitigation due to the low control qubit quantity and associated low quantum circuit depth.

In connection therewith, the one or more embodiments described herein can provide useful and practical applications of computers, thus providing enhanced (e.g., improved and/or optimized) quantum system setup as compared to existing frameworks for determining vibrationally resolved electronic spectra. Overall, such computerized tools can constitute a concrete and tangible technical improvement in the field of quantum processing.

One or more embodiments described herein can be employed to perform two or more processes at least partially in parallel with one another for one or more times t for one or more different vibronic spectra being sought. For example, decomposing (step 703, FIG. 7) can be performed for two or more quantities b at least partially at a same time as one another, which also can be performed at least partially at a same time as two or more other processes, such as transforming (step 708, FIG. 7), controlling (step 710, FIG. 7) and/or any other process discussed herein. Further, such processes can be further scalable, as noted, for more than one time t and/or for more than one molecule of interest at least partially at a same time as one another.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to determination of a vibrationally resolved electronic spectrum for a molecule, as compared to existing systems and/or techniques unable to provide such efficiencies. Systems, computer-implemented methods and/or computer program products providing performance of these processes are of great utility in the fields of quantum computing and molecular vibration spectra analysis and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically control quantum circuit execution at a plurality of qubits of a quantum system as the one or more embodiments described herein can provide these processes. For another example, a human, or even thousands of humans, cannot efficiently, accurately and/or effectively automatically or even partially automatically generate computer-usable data relative to initial qubit states, quantum gates and/or quantum circuits for employment by a quantum system as the one or more embodiments described herein can provide these processes. Moreover, neither can the human mind nor a human with pen and paper conduct these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, comprising: a memory that stores computer executable components; and a processor, operably coupled to the memory, that executes the computer executable components stored in the memory, wherein the computer executable components comprise: a determining component that determines a non-arbitrary auxiliary quantum state to be prepared at a quantum system in correlation with execution of a quantum algorithm that represents an autocorrelation function corresponding to a specified vibronic spectrum; and an executing component that obtains a set of measurements corresponding to the autocorrelation function by controlling an execution of the quantum algorithm based on the non-arbitrary auxiliary quantum state as an initial qubit state for the quantum system.

The system of the preceding paragraph, wherein the executing component controls preparation of the non-arbitrary auxiliary quantum state at the quantum system, the non-arbitrary auxiliary quantum state comprising a zero state for a majority of qubits to be employed for the execution and a one state for at least one of the qubits to be employed for the execution.

The system of any preceding paragraph, wherein the executing component controls use of the non-arbitrary auxiliary quantum state at less than all sub-executions, of the execution, of parallelly-executable elements of the quantum algorithm, and wherein the sub-executions result in separate sub-measurements of the set of measurements.

The system of any preceding paragraph, wherein the determining component determines the non-arbitrary auxiliary quantum state such that employment of the non-arbitrary auxiliary quantum state for plural elements, of a set of parallelly-executable elements of the quantum algorithm, at the quantum system, results in absence of exponential decay, for the plural elements, with a number of qubits of the quantum system that are employed for the plural elements.

The system of any preceding paragraph, further comprising: a transforming component that, prior to the execution, prepares at least one element, of a set of parallelly-executable elements of the quantum algorithm, to comprise directed rotation of a qubit of the quantum system, wherein the at least one element is transformed, by the transforming component, to comprise a rotation gate about a corresponding x-axis.

The system of any preceding paragraph, wherein the autocorrelation function comprises both real components and imaginary components, and wherein the computer executable components further comprise: a decomposing component that decomposes parallelly-executable elements of the quantum algorithm into terms comprising real components and imaginary components; and an evaluating component that defines the autocorrelation function in terms of the real components and the imaginary components based on expectation values corresponding to the set of measurements.

The system of any preceding paragraph, wherein the quantum algorithm comprises a set of parallelly-executable elements comprising:

$${{{b}_{1} ≡ {\vert 〈 0 \vert {e}^{- iHt} \vert 0 〉 \vert}^{2} {b}_{2} ≡ {\vert 〈 {ψ}_{aux} \vert {e}^{- iHt} \vert 0 〉 \vert}^{2} {b}_{3} ≡ \vert \frac{1}{\sqrt{2}} ( 〈 0 \vert + 〈 {ψ}_{aux} \vert ) {e}^{- iHt} \vert 0 〉 \vert}^{2} {b}_{4} ≡ \vert \frac{1}{\sqrt{2}} ( 〈 0 \vert + i 〈 {ψ}_{aux} \vert ) {e}^{- iHt} \vert 0 〉 \vert}^{2} ,$$

wherein H is a Hamiltonian, i is a conventional complex number i, and t is a specified time of the autocorrelation function.

The system of any preceding paragraph, wherein the computer executable components further comprise: an iterating component that controls a first number of additional repetitions of the execution of the quantum algorithm equal to a second number of different times t of the autocorrelation function to be employed in the quantum algorithm, wherein the second number is based on a target spectral accuracy for spectral resolution corresponding to the specified vibronic spectrum.

The system of any preceding paragraph, wherein the computer executable components further comprise: an evaluating component that controls construction of the specified vibronic spectrum based on expectation values that correspond to the set of measurements and additional sets of measurements corresponding to the different times t.

A computer-implemented method, comprising: determining, by a system operatively coupled to a processor, a non-arbitrary auxiliary quantum state to be prepared at a quantum system in correlation with execution of a quantum algorithm that represents an autocorrelation function corresponding to a specified vibronic spectrum; and obtaining, by the system, a set of measurements corresponding to the autocorrelation function by controlling an execution of the quantum algorithm based on the non-arbitrary auxiliary quantum state as an initial qubit state for the quantum system.

The computer-implemented method of the preceding paragraph, further comprising: controlling, by the system, preparation of the non-arbitrary auxiliary quantum state at the quantum system, the non-arbitrary auxiliary quantum state comprising a zero state for a majority of qubits to be employed for the execution and a one state for at least one of the qubits to be employed for the execution.

The computer-implemented method of any preceding paragraph, further comprising: controlling, by the system, use of the non-arbitrary auxiliary quantum state at less than all sub-executions, of the execution, of parallelly-executable elements of the quantum algorithm, and wherein the sub-executions result in separate sub-measurements of the set of measurements.

The computer-implemented method of any preceding paragraph, further comprising: determining, by the system, the non-arbitrary auxiliary quantum state such that employment of the non-arbitrary auxiliary quantum state for plural elements, of a set of parallelly-executable elements of the quantum algorithm, at the quantum system, results in maintaining of exponential distinguishability of plural elements from another element, which is different from the plural elements and also is of the set of parallelly-executable elements of the quantum algorithm.

The computer-implemented method of any preceding paragraph, further comprising: prior to the execution, preparing, by the system, at least one element, of a set of parallelly-executable elements of the quantum algorithm, to comprise directed rotation of a qubit of the quantum system; and transforming, by the system, the at least one element to comprise a rotation gate about a corresponding x-axis.

The computer-implemented method of any preceding paragraph, wherein the autocorrelation function comprises both real components and imaginary components, and wherein the computer-implemented method further comprises: decomposing, by the system, parallelly-executable elements of the quantum algorithm into terms comprising real components and imaginary components; and defining, by the system, the autocorrelation function in terms of the real components and the imaginary components based on expectation values corresponding to the set of measurements.

The computer-implemented method of any preceding paragraph, further comprising: controlling, by the system, a first number of additional repetitions of the execution of the quantum algorithm equal to a second number of different times t of the autocorrelation function to be employed in the quantum algorithm, wherein the second number is based on a target spectral accuracy for spectral resolution corresponding to the specified vibronic spectrum; and controlling, by the system, construction of the specified vibronic spectrum based on expectation values that correspond to the set of measurements and additional sets of measurements corresponding to the different times t.

A computer program product facilitating a process to determine a vibrationally resolved electronic spectrum of a molecule, the computer program product comprising a computer readable storage medium having program instructions embodied therewith, the program instructions executable by a processor to cause the processor to: determine, by the processor, a non-arbitrary auxiliary quantum state to be prepared at a quantum system in correlation with execution of a quantum algorithm that represents an autocorrelation function corresponding to a specified vibronic spectrum; and obtain, by the processor, a set of measurements corresponding to the autocorrelation function by controlling an execution of the quantum algorithm based on the non-arbitrary auxiliary quantum state as an initial qubit state for the quantum system.

The computer program product of the preceding paragraph, wherein the program instructions are further executable by the processor to cause the processor to: control, by the processor, preparation of the non-arbitrary auxiliary quantum state at the quantum system, the non-arbitrary auxiliary quantum state comprising a zero state for a majority of qubits to be employed for the execution and a one state for at least one of the qubits to be employed for the execution

The computer program product of any preceding paragraph, wherein the program instructions are further executable by the processor to cause the processor to: control, by the processor, use of the non-arbitrary auxiliary quantum state at less than all sub-executions, of the execution, of parallelly-executable elements of the quantum algorithm, and wherein the sub-executions result in separate sub-measurements of the set of measurements.

The computer program product of any preceding paragraph, wherein the program instructions are further executable by the processor to cause the processor to: determine, by the processor, the non-arbitrary auxiliary quantum state such that employment of the non-arbitrary auxiliary quantum state for plural elements, of a set of parallelly-executable elements of the quantum algorithm, at the quantum system, results in: absence of exponential decay, for the plural elements, with a number of qubits of the quantum system employed for the plural elements, and maintaining of exponential distinguishability of the plural elements from another element, which is different from the plural elements and also is of the set of parallelly-executable elements of the quantum algorithm.

### Computing Environment Description

Turning next to FIG. 11, a detailed description is provided of additional context for the one or more embodiments described herein at FIGS. 1-10.

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a VRES evaluation code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum system or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, one or more instructions for performing the inventive methods may be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine that collects and stores helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate via WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “cpossesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor, operably coupled to the memory, that executes the computer executable components stored in the memory, wherein the computer executable components comprise:
a determining component that determines a non-arbitrary auxiliary quantum state to be prepared at a quantum system in correlation with execution of a quantum algorithm that represents an autocorrelation function corresponding to a specified vibronic spectrum; and
an executing component that obtains a set of measurements corresponding to the autocorrelation function by controlling an execution of the quantum algorithm based on the non-arbitrary auxiliary quantum state as an initial qubit state for the quantum system.

2. The system of claim 1, wherein the executing component controls preparation of the non-arbitrary auxiliary quantum state at the quantum system, the non-arbitrary auxiliary quantum state comprising a zero state for a majority of qubits to be employed for the execution and a one state for at least one of the qubits to be employed for the execution.

3. The system of claim 1, wherein the executing component controls use of the non-arbitrary auxiliary quantum state at less than all sub-executions, of the execution, of parallelly-executable elements of the quantum algorithm, and wherein the sub-executions result in separate sub-measurements of the set of measurements.

4. The system of claim 1, wherein the determining component determines the non-arbitrary auxiliary quantum state such that employment of the non-arbitrary auxiliary quantum state for plural elements, of a set of parallelly-executable elements of the quantum algorithm, at the quantum system, results in absence of exponential decay, for the plural elements, with a number of qubits of the quantum system that are employed for the plural elements.

5. The system of claim 1, further comprising:
a transforming component that, prior to the execution, prepares at least one element, of a set of parallelly-executable elements of the quantum algorithm, to comprise directed rotation of a qubit of the quantum system,
wherein the at least one element is transformed, by the transforming component, to comprise a rotation gate about a corresponding x-axis.

6. The system of claim 1,
wherein the autocorrelation function comprises both real components and imaginary components, and
wherein the computer executable components further comprise:
a decomposing component that decomposes parallelly-executable elements of the quantum algorithm into terms comprising real components and imaginary components; and
an evaluating component that defines the autocorrelation function in terms of the real components and the imaginary components based on expectation values corresponding to the set of measurements.

7. The system of claim 1, wherein the quantum algorithm comprises a set of parallelly-executable elements comprising:
$${{{b}_{1} ≡ {\vert 〈 0 \vert {e}^{- iHt} \vert 0 〉 \vert}^{2} {b}_{2} ≡ {\vert 〈 {ψ}_{aux} \vert {e}^{- iHt} \vert 0 〉 \vert}^{2} {b}_{3} ≡ \vert \frac{1}{\sqrt{2}} ( 〈 0 \vert + 〈 {ψ}_{aux} \vert ) {e}^{- iHt} \vert 0 〉 \vert}^{2} {b}_{4} ≡ \vert \frac{1}{\sqrt{2}} ( 〈 0 \vert + i 〈 {ψ}_{aux} \vert ) {e}^{- iHt} \vert 0 〉 \vert}^{2} ,$$
wherein H is a Hamiltonian, i is a conventional complex number i, and t is a specified time of the autocorrelation function.

8. The system of claim 1, wherein the computer executable components further comprise:
an iterating component that controls a first number of additional repetitions of the execution of the quantum algorithm equal to a second number of different times t of the autocorrelation function to be employed in the quantum algorithm,
wherein the second number is based on a target spectral accuracy for spectral resolution corresponding to the specified vibronic spectrum.

9. The system of claim 8, wherein the computer executable components further comprise:
an evaluating component that controls construction of the specified vibronic spectrum based on expectation values that correspond to the set of measurements and to additional sets of measurements corresponding to the different times t.

10. A computer-implemented method, comprising:
determining, by a system operatively coupled to a processor, a non-arbitrary auxiliary quantum state to be prepared at a quantum system in correlation with execution of a quantum algorithm that represents an autocorrelation function corresponding to a specified vibronic spectrum; and
obtaining, by the system, a set of measurements corresponding to the autocorrelation function by controlling an execution of the quantum algorithm based on the non-arbitrary auxiliary quantum state as an initial qubit state for the quantum system.

11. The computer-implemented method of claim 10, further comprising:
controlling, by the system, preparation of the non-arbitrary auxiliary quantum state at the quantum system, the non-arbitrary auxiliary quantum state comprising a zero state for a majority of qubits to be employed for the execution and a one state for at least one of the qubits to be employed for the execution.

12. The computer-implemented method of claim 10, further comprising:
controlling, by the system, use of the non-arbitrary auxiliary quantum state at less than all sub-executions, of the execution, of parallelly-executable elements of the quantum algorithm, and wherein the sub-executions result in separate sub-measurements of the set of measurements.

13. The computer-implemented method of claim 10, further comprising:
determining, by the system, the non-arbitrary auxiliary quantum state such that employment of the non-arbitrary auxiliary quantum state for plural elements, of a set of parallelly-executable elements of the quantum algorithm, at the quantum system, results in maintaining of exponential distinguishability of plural elements from another element, which is different from the plural elements and also is of the set of parallelly-executable elements of the quantum algorithm.

14. The computer-implemented method of claim 10, further comprising:
prior to the execution, preparing, by the system, at least one element, of a set of parallelly-executable elements of the quantum algorithm, to comprise directed rotation of a qubit of the quantum system; and
transforming, by the system, the at least one element to comprise a rotation gate about a corresponding x-axis.

15. The computer-implemented method of claim 10,
wherein the autocorrelation function comprises both real components and imaginary components, and
wherein the computer-implemented method further comprises:
decomposing, by the system, parallelly-executable elements of the quantum algorithm into terms comprising real components and imaginary components; and
defining, by the system, the autocorrelation function in terms of the real components and the imaginary components based on expectation values corresponding to the set of measurements.

16. The computer-implemented method of claim 10, further comprising:
controlling, by the system, a first number of additional repetitions of the execution of the quantum algorithm equal to a second number of different times t of the autocorrelation function to be employed in the quantum algorithm,
wherein the second number is based on a target spectral accuracy for spectral resolution corresponding to the specified vibronic spectrum; and
controlling, by the system, construction of the specified vibronic spectrum based on expectation values that correspond to the set of measurements and additional sets of measurements corresponding to the different times t.

17. A computer program product facilitating a process to determine a vibrationally resolved electronic spectrum of a molecule, the computer program product comprising a computer readable storage medium having program instructions embodied therewith, the program instructions executable by a processor to cause the processor to:
determine, by the processor, a non-arbitrary auxiliary quantum state to be prepared at a quantum system in correlation with execution of a quantum algorithm that represents an autocorrelation function corresponding to a specified vibronic spectrum; and
obtain, by the processor, a set of measurements corresponding to the autocorrelation function by controlling an execution of the quantum algorithm based on the non-arbitrary auxiliary quantum state as an initial qubit state for the quantum system.

18. The computer program product of claim 17, wherein the program instructions are further executable by the processor to cause the processor to:
control, by the processor, preparation of the non-arbitrary auxiliary quantum state at the quantum system, the non-arbitrary auxiliary quantum state comprising a zero state for a majority of qubits to be employed for the execution and a one state for at least one of the qubits to be employed for the execution.

19. The computer program product of claim 17, wherein the program instructions are further executable by the processor to cause the processor to:
control, by the processor, use of the non-arbitrary auxiliary quantum state at less than all sub-executions, of the execution, of parallelly-executable elements of the quantum algorithm, and wherein the sub-executions result in separate sub-measurements of the set of measurements.

20. The computer program product of claim 17, wherein the program instructions are further executable by the processor to cause the processor to:
determine, by the processor, the non-arbitrary auxiliary quantum state such that employment of the non-arbitrary auxiliary quantum state for plural elements, of a set of parallelly-executable elements of the quantum algorithm, at the quantum system, results in:
absence of exponential decay, for the plural elements, with a number of qubits of the quantum system employed for the plural elements, and
maintaining of exponential distinguishability of the plural elements from another element, which is different from the plural elements and also is of the set of parallelly-executable elements of the quantum algorithm.
